(19) United States
(12) Patent Application Publication
(10) Pub. No.: US 2009/0189810 A1
(43) Pub. Date: Jul. 30, 2009

(54) WEIGHTED AIDING FOR POSITIONING SYSTEMS

(75) Inventor: David Murray, Mission Viejo, CA (US)

Correspondence Address: FIALA & WEAVER, P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/354,127

(22) Filed: Jan. 15, 2009

Related U.S. Application Data
(60) Provisional application No. 61/023,278, filed on Jan. 24, 2008.

(51) Int. Cl. G01S 5/00

(52) U.S. Cl. 342/357.14; 342/450; 342/357.06

(57) ABSTRACT

Location information provided by multiple positioning systems is combined to provide an estimated user location. In performing the combination, location information provided by the positioning system that is currently deemed more reliable is provided greater weight than the location information provided from the other positioning system(s). Alternatively, one of multiple positioning systems is selected to calculate an estimated user location. The selected system is the one that is currently deemed more reliable based on some indicia of reliability. Using either approach, an accurate estimate of a user's location can be provided both in rural areas or other sparsely-populated areas as well as in urban areas or other areas prone to high multipath effects.

### CROSS-REFERENCE TO RELATED APPLICATIONS

This application claims priority to U.S. Provisional Patent Application No. 61/023,278, filed Jan. 24, 2008, the entirety of which is incorporated by reference herein.

### BACKGROUND OF THE INVENTION

1. Field of the Invention

The invention generally relates to positioning systems and devices configured to use such systems to determine the location of a user.

2. Background

Various systems exist for automatically determining the location of a user. Such systems will be referred to herein as “positioning systems,” although such systems are also referred to in the literature as “location determination systems.”

One of the most widely-used positioning systems is the Global Positioning System (GPS). As will be appreciated by persons skilled in the relevant art(s), GPS is the only fully functional Global Navigation Satellite System (GNSS). GPS utilizes a constellation of at least 24 medium Earth orbit satellites that transmit precise microwave signals, thereby enabling a properly-configured GPS receiver to determine its location, speed/direction and time. GPS has become a widely used aid to navigation worldwide, and a useful tool for map-making, land surveying, commerce, and scientific uses. A GPS receiver calculates its position by measuring the distance between itself and three or more GPS satellites. The GPS receiver determines the distance to each satellite by measuring a time delay between the transmission and reception of GPS microwave signals. These signals also carry information about each satellite's location and general system health (known as almanac and ephemeris data). By determining the position of, and distance to, at least three satellites, the GPS receiver can calculate its position using trilateration. GPS receivers typically do not have perfectly accurate clocks and therefore track one or more additional satellites, using their atomic clocks to correct the GPS receiver's own clock error.

GPS receivers can be extremely accurate. However, there are certain factors that can reduce the accuracy of location information provided by a GPS receiver. One of the key factors in this regard is multipath effects. Multipath effects result when GPS microwave signals are reflected off structures or terrain surrounding a GPS receiver. Urban areas having a high density of large buildings (sometimes referred to as “urban canyons”) are areas that are known to generate severe multipath effects. Other areas prone to multipath effects may include mountainous areas, densely wooded areas, and indoor environments. In such areas, location information provided using GPS may be highly unreliable.

Alternative positioning systems exist that are not as susceptible to multipath effects. For example, positioning systems based on the use of wireless local area networks (WLAN) (generally referred to herein as “WLAN positioning systems”) are not as susceptible to multipath effects. WLAN positioning systems use the popular 802.11 network infrastructure to determine the user location. Many applications have been built on top of WLAN positioning systems to support pervasive computing. These include location-sensitive content delivery, direction finding, asset tracking and emergency notification.

In a WLAN positioning system, a user device determines its position by comparing a wireless signal from a single access point, or multiple access points to a previously obtained database of access point positions, or by measuring the strength of wireless signals received from various 802.11 wireless access points, which act as points of reference. The user device may be, for example, a laptop or personal digital assistant (PDA) equipped with an 802.11 card.

Without interference, the strength of a signal from a wireless access point decays logarithmically with distance. However, in indoor environments, the wireless channel is often very noisy and the radio frequency (RF) signal can suffer from reflection, diffraction and the above-noted multipath effects, which make the signal strength a complicated function of distance. To overcome this problem, WLAN positioning systems tabulate this function by sampling it at selected locations in the area of interest. This tabulation is often referred to in the literature as a “radio map,” which captures the signature of each access point at certain points in the area of interest.

WLAN positioning systems usually work in two phases: an offline phase and a location determination phase. During the offline phase, the radio map is constructed. In the location determination phase, a vector of samples received from multiple wireless access points (each entry is a sample from one access point) is compared to the radio map and the “nearest” match is returned as the estimated user location. Different WLAN location determination techniques differ in the way they construct the radio map and in the algorithm they use to compare a received signal strength vector to the stored radio map in the location determination phase.

Because WLAN positioning systems take multipath effects (as well as other types of interference) into account when generating the radio map, such systems tend to be more accurate than GPS in areas of high multipath distortion, such as in urban areas and indoor environments. However, WLAN positioning systems require that the user be within transmission range of a number of wireless access points in order to operate. In urban areas this is generally not an issue, but in rural areas (and any other areas lacking a significant density of wireless access points) this factor can severely limit the system's accuracy and/or availability. GPS does not suffer from this limitation, and will thus generally perform better than WLAN positioning systems in such areas.

In yet another positioning system, a position may be obtained by comparing a wireless signal from a single cellular base station, or multiple cellular base stations to a previously obtained database of base station positions, or tri-lateration or triangulation may be performed using signals transmitted to and/or received from cellular base stations to determine a user location. Such systems will be referred to herein as “cellular positioning systems.” These systems may also out-perform GPS in urban environments. However, cellular positioning systems do not perform well or at all in areas that lie outside the cellular network. Also, cellular positioning systems are not completely immune from multipath effects.

What is needed, then, is a positioning technology that provides an accurate estimate of a user's location in rural or other sparsely-populated areas in a like manner to GPS but that also provides an accurate estimate of a user's location in urban areas or other areas prone to high multipath effects in a like manner to WLAN positioning systems and, to a lesser degree, cellular positioning systems.

### BRIEF SUMMARY OF THE INVENTION

In accordance with one aspect of the present invention, location information provided by multiple positioning systems is combined to provide an estimated user location. In performing the combination, location information provided by the positioning system that is currently deemed more reliable is provided greater weight than the location information provided from the other positioning system(s). Using this approach, an embodiment of the present invention may provide an accurate estimate of a user's location in rural areas or other sparsely-populated areas as well as in urban areas or other areas prone to high multipath effects.

In particular, a method for determining a location is described herein. In accordance with the method, an initial location is obtained. It is then determined whether the initial location is within a predefined area. The predefined area may be an area prone to multipath distortion. A final location is then calculated by combining a first location calculated using a first positioning system with a second location calculated using a second positioning system. The first positioning system may be, for example, a Global Positioning System (GPS). The second positioning system may be, for example, a non-GPS positioning system such as a wireless local area network (WLAN) positioning system or a cellular positioning system. Combining the first location and the second location includes weighting the second location more heavily than the first location in the combination if the initial location is within the predefined area and weighting the first location more heavily than the second location in the combination if the initial location is not within the predetermined area.

In accordance with the foregoing method, determining if the initial location is within a predefined area may include comparing the initial location to location information stored in a database. Obtaining an initial location may include obtaining a gross location and combining the first location and the second location to calculate a final location may include combining the first location and the second location to calculate a precise location. Obtaining the initial location may include obtaining the initial location using one of the first or the second positioning system.

A system is also described herein. The system includes first positioning logic, second positioning logic and control logic connected to the first positioning logic and the second positioning logic. The first positioning logic is configured to calculate a first location using a first positioning system. The second positioning logic is configured to calculate a second location using a second positioning system. The first positioning system may be, for example, GPS. The second positioning system may be, for example, a non-GPS positioning system such as a WLAN positioning system or a cellular positioning system. The control logic is configured to obtain an initial location, to determine if the initial location is within a predefined area, and to combine the first location and the second location to calculate a final location. The predefined area may include an area prone to multipath distortion. Combining the first location and the second location includes weighting the second location more heavily than the first location in the combination if the initial location is within the predefined area, and weighting the first location more heavily than the second location in the combination if the initial location is not within the predetermined area.

In accordance with the foregoing system, the control logic may be configured to determine if the initial location is within a predefined area by comparing the initial location to location information stored in a database. The control logic may also be configured to obtain an initial location by obtaining a gross location and to combine the first location and the second location to calculate a precise location. The control logic may be further configured to obtain the initial location from one of the first positioning logic or the second positioning logic.

An alternative method for determining a location is also described herein. In accordance with the method, an indication of the reliability of a first positioning system is obtained. A location is then calculated. Calculating the location includes combining a first location calculated using the first positioning system with a second location calculated using a second positioning system. Combining the first location and the second location includes either weighting the second location more heavily than the first location in the combination or weighting the first location more heavily than the second in the combination based on at least the indication of the reliability of the first positioning system.

In accordance with the foregoing method, the first positioning system may be any of GPS, a WLAN positioning system or a cellular positioning system. The second positioning system also may be any of GPS, a WLAN positioning system or a cellular positioning system, provided it is of a different type than the first positioning system. Calculating a location may further include combining the first location calculated using the first positioning system with the second location calculated using the second positioning system and a third location calculated using a third positioning system. The third positioning system also may be any of GPS, a WLAN positioning system or a cellular positioning system, provided it is of a different type than the first and second positioning systems.

An alternative system is also described herein. The system includes first positioning logic, second positioning logic and control logic connected to the first positioning logic and the second positioning logic. The first positioning logic is configured to calculate a first location using a first positioning system. The second positioning logic is configured to calculate a second location using a second positioning system. The control logic is configured to obtain an indication of the reliability of the first positioning system and to calculate a location by combining the first location with the second location. Combining the first location and the second location comprises either weighting the second location more heavily than the first location in the combination or weighting the first location more heavily than the second in the combination based on at least the indication of the reliability of the first positioning system.

In accordance with the foregoing system, the first positioning system may be any of GPS, a WLAN positioning system or a cellular positioning system. The second positioning system also may be any of GPS, a WLAN positioning system or a cellular positioning system, provided it is of a different type than the first positioning system. The system may further include third positioning logic configured to calculate a third location using a third positioning system. The control logic may be configured to calculate the location by combining the first location calculated by the first positioning logic with the second location calculated by the second positioning logic and a third location calculated by the third positioning logic. The third positioning system also may be any of GPS, a WLAN positioning system or a cellular positioning system, provided it is of a different type than the first and second positioning systems.

In accordance with another aspect of the present invention, one of multiple positioning systems is selected to calculate an estimated user location. The one of the multiple positioning systems that is selected is that system that is currently deemed more reliable based on some indicia of reliability. This approach also permits an embodiment of the present invention to provide an accurate estimate of a user's location in rural areas or other sparsely-populated areas as well as in urban areas or other areas prone to high multipath effects.

In particular, a method for determining a location is described herein. In accordance with the method, an indication of the reliability of a first positioning system is obtained. Then a location is calculated. Calculating the location includes selectively using either a first positioning system or a second positioning system, wherein the selection is based on at least the indication of the reliability of the first positioning system.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram an example system for determining a user location in accordance with one embodiment of the present invention.

FIG. 2 is a block diagram of a system for determining a user location in accordance with an embodiment of the present invention in which a first location is calculated using a Global Positioning System (GPS) and a second location is calculated using non-GPS positioning system.

FIG. 3 depicts elements of a system for determining a user location in accordance with an embodiment of the present invention in which location information concerning predefined areas of high multipath interference is stored in a database that is local with respect to a user device.

FIG. 4 depicts elements of a system for determining a user location in accordance with an embodiment of the present invention in which location information concerning predefined areas of high multipath interference is stored in a database that is remote with respect to a user device.

FIG. 5 depicts a flowchart of a method for determining a user location using multiple positioning systems in which user location is considered in accordance with an embodiment of the present invention.

FIG. 6 depicts a flowchart of a method for determining a user location using multiple positioning systems in which indicia of reliability are considered in accordance with an embodiment of the present invention.

FIG. 7 is a block diagram of a system for determining a user location in accordance with an embodiment of the present invention in which a first location is calculated using a cellular positioning system and a second location is calculated using a wireless local area network (WLAN) positioning system.

FIG. 8 is a block diagram of a system for determining a user location in accordance with an embodiment of the present invention that uses location information calculated using GPS, a WLAN positioning system, and a cellular positioning system.

FIG. 9 depicts a flowchart of a method for determining a user location by selectively using one of multiple positioning systems based on indicia of reliability in accordance with an embodiment of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Weighted Aiding for Positioning Systems

In accordance with one aspect of the present invention, location information provided by multiple positioning systems is combined to provide an estimated user location. In performing the combination, location information provided by the positioning system that is currently deemed more reliable is provided greater weight than the location information provided from the other positioning system(s). Using this approach, an embodiment of the present invention may provide an accurate estimate of a user's location in rural areas or other sparsely-populated areas as well as in urban areas or other areas prone to high multipath effects.

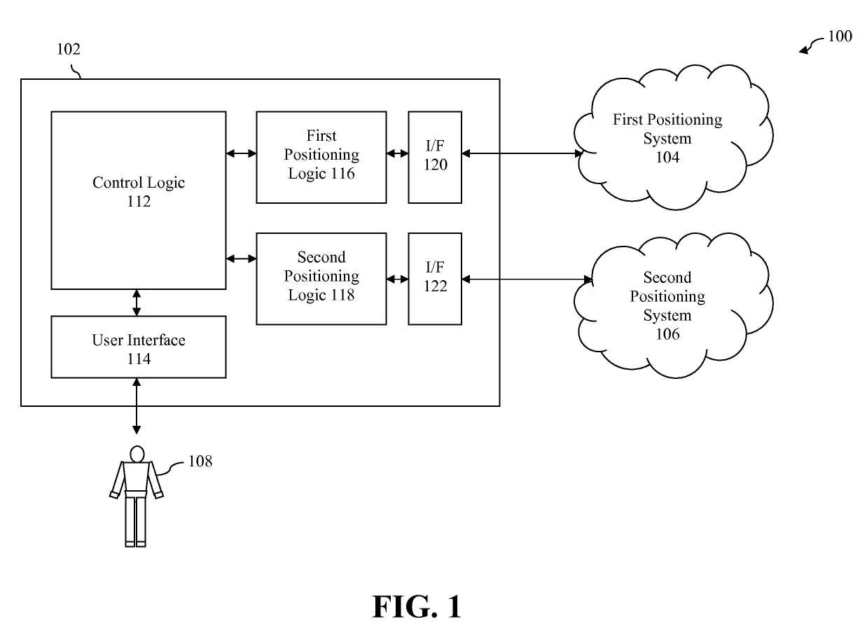

FIG. 1 is a block diagram of an example system 100 for determining a user location that implements the foregoing approach. As shown in FIG. 1, system 100 includes a user device 102 that is configured to communicate with a first positioning system 104 and a second positioning system 106. User device 102 is further configured to provide a user 108 with an estimate of the user's location. To this end, user device 102 includes first positioning logic 116 that is configured to use first positioning system 104 to calculate a first location and second positioning logic 118 that is configured to use second positioning system 106 to calculate a second location. User device 102 further includes a first interface 120 that is configured to allow first positioning logic 116 to communicate with elements of first positioning system 104 and a second interface 122 that is configured to allow second positioning logic 118 to communicate with elements of second positioning system 106.

User device 102 further includes control logic 112 that is connected to first positioning logic 116 and second positioning logic 118. Control logic 112 is configured to receive the first location calculated by first positioning logic 116 and the second location calculated by second positioning logic 118 and to combine them to calculate a final location. As will be described in more detail herein, in performing this combination, control logic 112 is configured to weight either the first location more heavily than the second location or to weight the second location more heavily than the first location depending on which of first positioning system 104 or second positioning system 106 is currently deemed more reliable.

After the final location is determined by control logic 112, control logic 112 provides the final location to user 108 by way of a user interface 114. As will be appreciated by persons skilled in the relevant art(s), the final location may be provided to user 108 in a variety of formats depending on how user interface 114 is implemented. For example, the final location information may be provided as latitude and longitude coordinates, an address, an identification of a point of interest, or a marker on a map. These examples are not intended to be limiting and persons skilled in the relevant art(s) will readily appreciate that the final location may be provided to user 108 using other formats as well.

User device 102 is intended to broadly represent any device or system capable of performing the functions attributed to user device 102 as described above and as described in more detail herein. For example and without limitation, user device 102 may comprise a handheld location determination device, a personal digital assistant (PDA), a cellular telephone, a laptop computer, or a dashboard navigation system.

It is to be understood that each of the elements of user device 102 may be implemented in hardware using analog and/or digital circuits, in software, through the execution of instructions by one or more general purpose or special-purpose processors, or as a combination of hardware and software.

1. Weighted Aiding based on User Location

In accordance with one embodiment of the present invention, the positioning systems available to user device 102 include a Global Positioning System (GPS) and a non-GPS based positioning system. The determination of which positioning system is more reliable is made based on a current estimate of the location of the user. In particular, if the current estimated location of the user indicates that the user is located within an area that is not prone to multipath effects, then GPS is deemed the more reliable system and a location calculated using GPS is weighted more heavily when combined with a location calculated using the non-GPS positioning system. However, if the current estimated location of the user indicates that the user is located within an area that is prone to multipath effects, then the non-GPS positioning system is deemed the more reliable system and a location calculated using the non-GPS positioning system is weighted more heavily when combined with a location calculated using GPS.

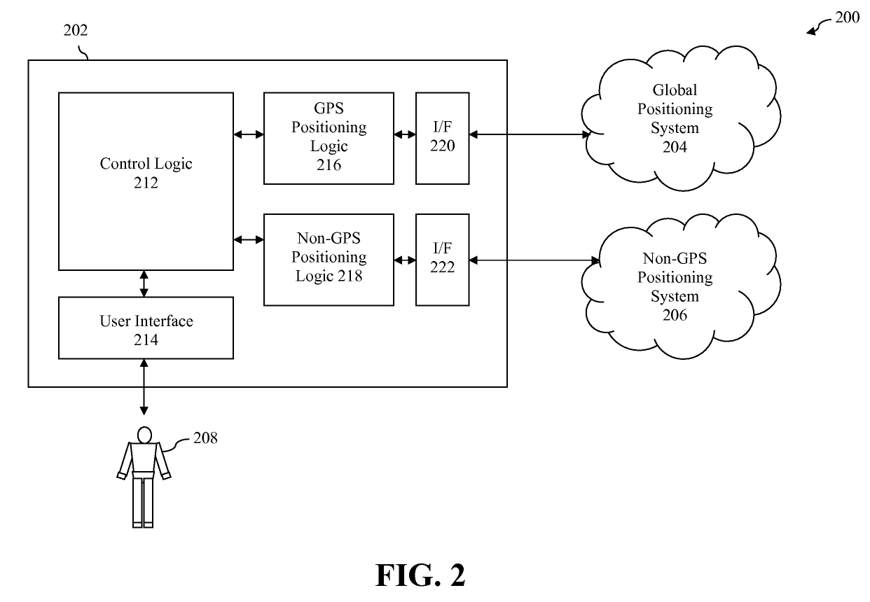

FIG. 2 is a block diagram of a system 200 in accordance with this embodiment. System 200 of FIG. 2 is a specific implementation of the more general system 100 of FIG. 1.

As shown in FIG. 2, system 200 includes a user device 202 that is configured to communication with a GPS 204 and a non-GPS positioning system 206. Non-GPS positioning system may be, for example, a wireless local area network (WLAN) positioning system or a cellular positioning system.

User device 202 is configured to provide a user 208 with an estimate of the user's location. To this end, user device 202 includes GPS positioning logic 216 that is configured to use GPS 204 to calculate a first location and non-GPS positioning logic 218 that is configured to use non-GPS positioning system 206 to calculate a second location. User device 202 further includes a GPS interface 220 that is configured to allow GPS positioning logic 216 to communicate with elements of GPS 204 and a non-GPS interface 222 that is configured to allow non-GPS positioning logic 218 to communicate with elements of non-GPS positioning system 206.

The manner in which GPS 204 is implemented is well-documented and will be understood by persons skilled in the relevant art(s). The manner in which GPS positioning logic 216 and GPS interface 220 may be configured to use GPS 204 to calculate a location is also well-documented and will be understood by persons skilled in the relevant art(s). Furthermore, a variety of GPS receiver designs are publicly available and a variety of GPS receivers are commercially available. Persons skilled in the relevant art(s) will readily appreciate that such GPS receivers and receiver designs may be used to implement GPS positioning logic 216 and GPS interface 220 of user device 202.

Similarly, a wide variety of techniques for implementing WLAN positioning systems and cellular positioning systems have been described in the literature and/or are commercially available. As an example, various WLAN positioning systems are described in Li et al., “A New Method for Yielding a Database of Location Fingerprints in WLAN” Communications, IEE Proceedings—, Volume 152, Issue 5, Oct. 7, 2005, pages 580-586 and in Youssef et al., “Toward an Optimal Strategy for WLAN Location Determination Systems,” International Journal of Modelling and Simulation, Vol. 27, Issue 1, 2007, each of which is incorporated by reference in its entirety herein. As a further example, various cellular positioning systems are described in Drane et al., “Positioning GSM Telephones,” IEEE Communications Magazine, April 1998, pages 46-59, which is incorporated by reference in its entirety herein. Accordingly, persons skilled in the relevant art(s) will readily understand how to implement non-GPS positioning system 206, and how to configure non-GPS positioning logic and non-GPS interface 222 to use that system to determine a location. Therefore, such description need not be provided herein.

User device 202 further includes control logic 212 that is connected to GPS positioning logic 216 and non-GPS positioning logic 218. Control logic 212 is configured to obtain an initial location, to determine if the initial location is within a predefined area, and to combine the first location calculated by GPS positioning logic 216 and the second location calculated by non-GPS positioning logic 218 to calculate a final location. The predefined area may include an area prone to multipath distortion. In combining the first location and the second location, control logic 212 is configured to weight the second location more heavily than the first location in the combination if the initial location is within the predefined area, and to weight the first location more heavily than the second location in the combination if the initial location is not within the predetermined area. This is because GPS 204 is likely to be less reliable than non-GPS positioning system 206 if user 208 is currently located in an area that is prone to high multipath distortion, whereas GPS 204 is more likely to be reliable than non-GPS positioning system 206 if user 208 is currently located in an area that is not prone to high multipath distortion. After the final location is determined by control logic 212, control logic 212 provides the final location to user 208 by way of a user interface 214.

As noted above, control logic 212 is configured to obtain an initial location and to determine if the initial location is within a predefined area. Control logic 212 may be configured to obtain the initial location by obtaining a current estimate of the user location from either GPS positioning logic 216 or non-GPS positioning logic 218. This estimate need not be as precise as the final location provided to user 208, since it is only used for determining if the user is within a predefined area and is not ultimately presented to user 208. Thus, the current estimate of the user location may be merely a gross location. By not requiring a precise location, an embodiment of the present invention can reduce the time and resource consumption associated with obtaining the initial location.

Control logic 212 may determine if the initial location is within a predefined area by comparing the initial location to location information stored in a database. The location information stored in the database may define a plurality of predefined areas, wherein each predefined area is an area prone to high multipath distortion, such as an urban area, mountainous area, or wooded area. The comparison may be performed algorithmically, via a look-up table, or using other techniques known to persons skilled in the relevant art(s) for comparing location information.

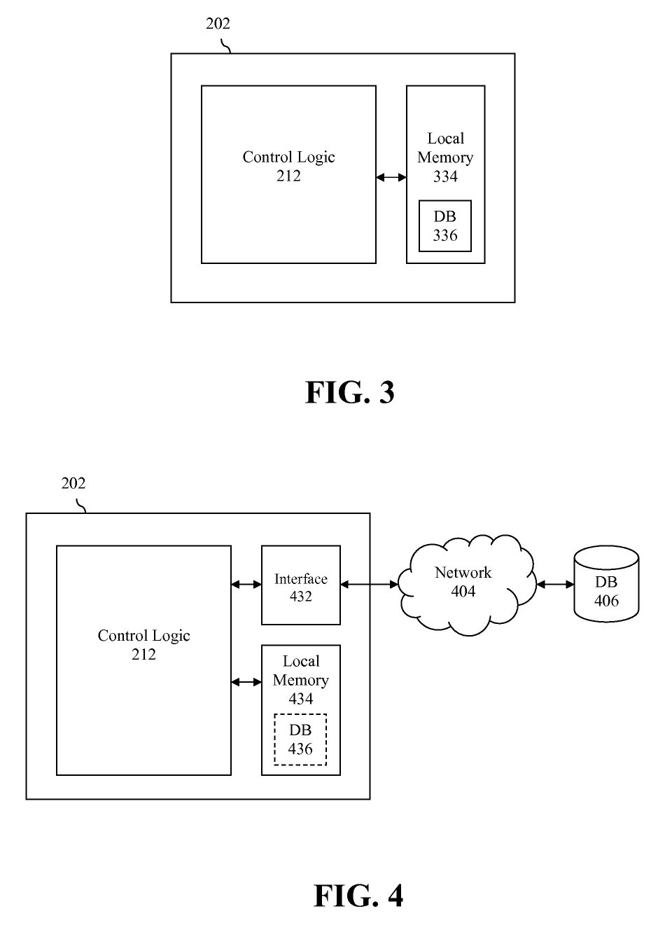

In one embodiment of the present invention, the database is stored in local memory of user device 202. Such an embodiment is illustrated in FIG. 3, which shows one implementation of user device 202 that includes a local memory 334. As shown in FIG. 3, local memory 334 stores a database 336 that includes location information concerning the predefined areas.

In an alternate embodiment of the present invention, the database is stored remotely with respect to user device 202. Such an embodiment is illustrated in FIG. 4, which shows one implementation of user device 202 that includes an interface 432 for accessing a remote database 406 over a network 404. The relevant location information concerning the predefined areas is stored in remote database 406. In one version of this implementation, the ultimate determination of whether the initial location is within a predefined area is made at the site of remote database 406 (e.g., by a server) responsive to a request from user device 202 and then the outcome of the determination is transmitted to user device 202 over network 404. In an alternate version of this implementation, the location information is downloaded from remote database 406 to a local database 436 stored in local memory 434 of user device 202. In this version, the determination of whether the initial location is within a predefined area is made by control logic 212 within user device 202.

Note that where non-GPS positioning system 206 is a WLAN positioning system, the definition of the predefined areas may be stored in conjunction with a radio map used for performing WLAN positioning. These elements may be stored locally or remotely with respect to user device 202.

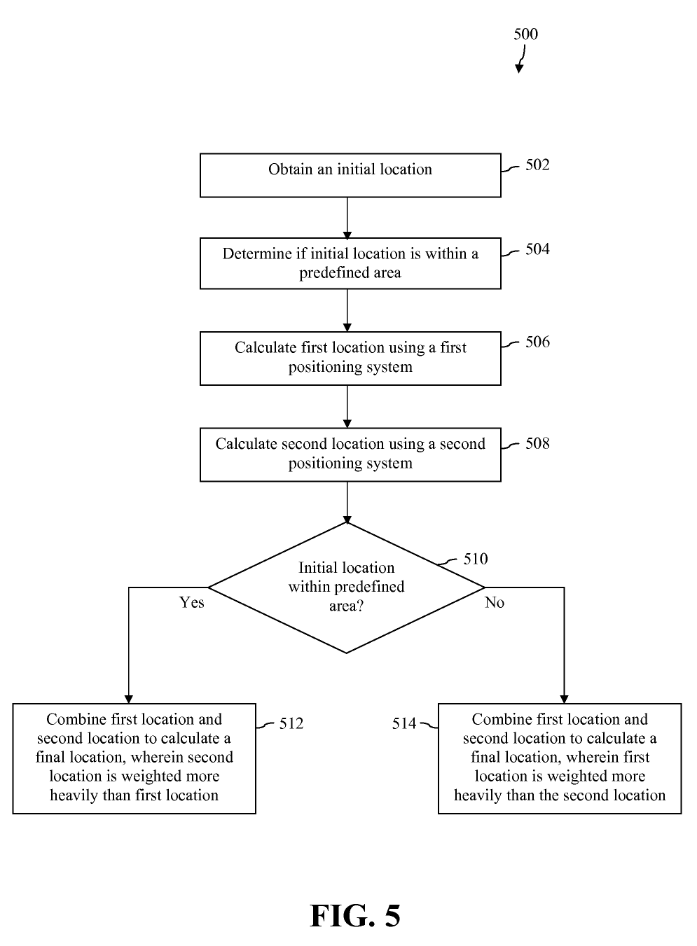

FIG. 5 depicts a flowchart 500 of a method for determining a user location that uses the foregoing weighted aiding approach. This method will now be described with continued reference to system 200 of FIG. 2, although the method is not limited to that embodiment. Persons skilled in the relevant art(s) will appreciate that other devices and systems may be used to implement the method of flowchart 500.

As shown in FIG. 5, the method of flowchart 500 begins at step 602 in which control logic 212 within user device 202 obtains an initial location. As discussed above, this step may include obtaining a current estimate of the user location from either GPS positioning logic 216 or non-GPS positioning logic 218. As also discussed above, the current estimate of the user location may be a gross location.

At step 504, control logic 212 determines if the initial location is within a predefined area. As previously discussed, the predefined area may be an area prone to high multipath distortion. As also previously discussed, this step may include comparing the initial location to location information stored in a local or remote database.

At step 506, GPS positioning logic 216 calculates a first location using GPS 204 and at step 508, non-GPS positioning logic 218 calculates a second location using non-GPS positioning system 206. The first location and the second location are each estimates of the current location of the user. These estimates may be more precise than the initial location obtained in step 502.

At decision step 510, control flows either to step 512 if the initial location was determined to be within the predefined area or to step 514 if the initial location was determined not to be within the predefined area. At step 512, control logic 212 combines the first location and second location to calculate a final location of the user, wherein the second location is weighted more heavily than the first location in the combination. At step 514, control logic 212 combines the first location and the second location to calculate a final location of the user, wherein the first location is weighted more heavily than the second location in the combination. In either case, the final location may be an estimate of the user's location that is more precise than the initial location obtained in step 502.

2. Weighted Aiding based on Indicia of Reliability

In the embodiment described above, an implicit determination is made as to which one of multiple positioning systems is more reliable based on whether a user is currently located in an area of high multipath distortion. However, the present invention is not limited to considering only this one indicator of reliability. There are, in fact, many factors that impact whether a given positioning system will provide reliable data at a particular point in time. An embodiment of the present invention considers one or more of these factors in determining whether one positioning system is more reliable than another. Location readings from each system are then combined, with the location from the more reliable system being weighted more heavily than the location from the other system.

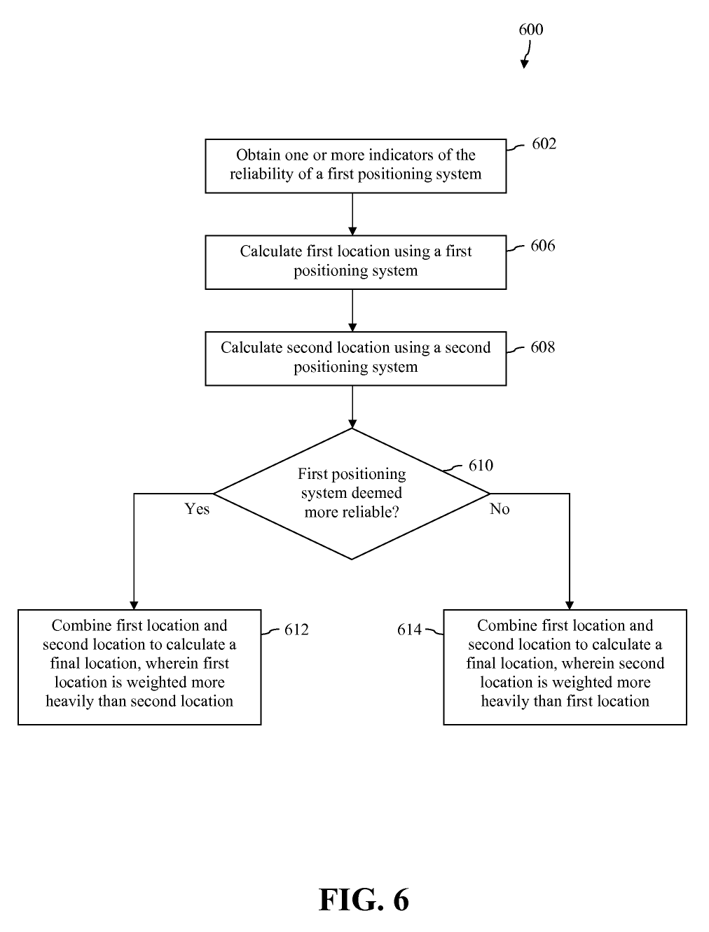

This approach will now be described with reference to FIG. 6. In particular, FIG. 6 depicts a flowchart 600 of a method for determining a user location using multiple positioning systems in which indicia of reliability are considered. The method of flowchart 600 will be described with continued reference to system 100 of FIG. 1, although the method is not limited to that embodiment. Persons skilled in the relevant art(s) will appreciate that other devices and systems may be used to implement the method of flowchart 600.

As shown in FIG. 6, the method of flowchart 600 begins at step 602, in which control logic 112 of user device 102 obtains one or more indicators of the reliability of first positioning system 104. The indicator(s) of reliability may be received from first positioning system 104 via interface 120. An indicator of reliability may be any value, signal, or item of information that relates to the current ability of first positioning system 104 to provide accurate location information. In the system described above in reference to FIGS. 2-5, the indicator of reliability was the current location of the user.

Where first positioning system 104 is GPS, some indicators of low reliability include an indication that the user is in a location prone to multipath distortion, an indication that the signal strength of one or more of the GPS microwave signals used for determining a location is weak, an indication that less than a certain number of GPS satellites (e.g., 4) are currently available, or an indication of poor geometry caused by the relative position of user device 102 and the available GPS satellites. Conversely, the absence of any or all of these conditions may be deemed an indicator of good reliability.

Where first positioning system 104 is a WLAN positioning system, some indicators of low reliability include an indication that there are less than a certain number of wireless access points (e.g., 3) within range or an indication that the signal strength of one or more wireless signals used for determining a location is weak. Conversely, the absence of either or both of these conditions may be deemed an indicator of good reliability.

Where first positioning system 104 is a cellular positioning system, some indicators of low reliability include an indication that the user is in an area prone to multipath distortion, an indication that less than a certain number of cellular base stations (e.g., 3) are within range, or an indication that the signal strength from one or more of the base stations being used for determining a location is weak. Conversely, the absence of any or all of these conditions may be deemed an indicator of good reliability.

At step 606, first positioning logic 116 calculates a first location using first positioning system 104 and at step 608, second positioning logic 118 calculates a second location using second positioning system 106. The first location and the second location are each estimates of the current location of the user.

At decision step 610, control logic 112 determines whether first positioning system 104 is more reliable than second positioning system 106. This determination is based on at least one indicator of reliability obtained in step 602. If first positioning system 104 is deemed more reliable than second positioning system 106, then control logic 112 combines the first location and the second location to calculate a final location of the user, wherein the first location is weighted more heavily than the second location in the combination, as shown at step 612. However, if first positioning system 104 is not deemed more reliable than second positioning system 106, then control logic 112 combines the first location and the second location to calculate a final location of the user, wherein the second location is weighted more heavily than the first location in the combination, as shown at step 614.

Although the method of flowchart 600 describes obtaining one or more indicators of the reliability of first positioning system 104, persons skilled in the relevant art(s) will appreciate that control logic 112 may also be configured to obtain one or more indicators of the reliability of second positioning system 106 as well. Decision step 610 may then apply an algorithm that determines which positioning system is more reliable based on the indicator(s) received for each positioning system. The location calculated using the positioning system that is deemed more reliable is then given greater weight than the location calculated using the other positioning system when combining the two locations.

Furthermore, unlike the embodiment described above in reference to FIG. 2, the method of flowchart 600 is not limited to an embodiment in which one positioning system is GPS and the other positioning system is a non-GPS positioning system. Generally speaking, first positioning system 104 may be any type of positioning system including but not limited to any of GPS, a WLAN positioning system, or a cellular positioning system. Likewise, second positioning system 106 may be any type of positioning system including but not limited to any of GPS, a WLAN positioning system, or a cellular positioning system, provided it is not the same type of positioning system as first positioning system 104.

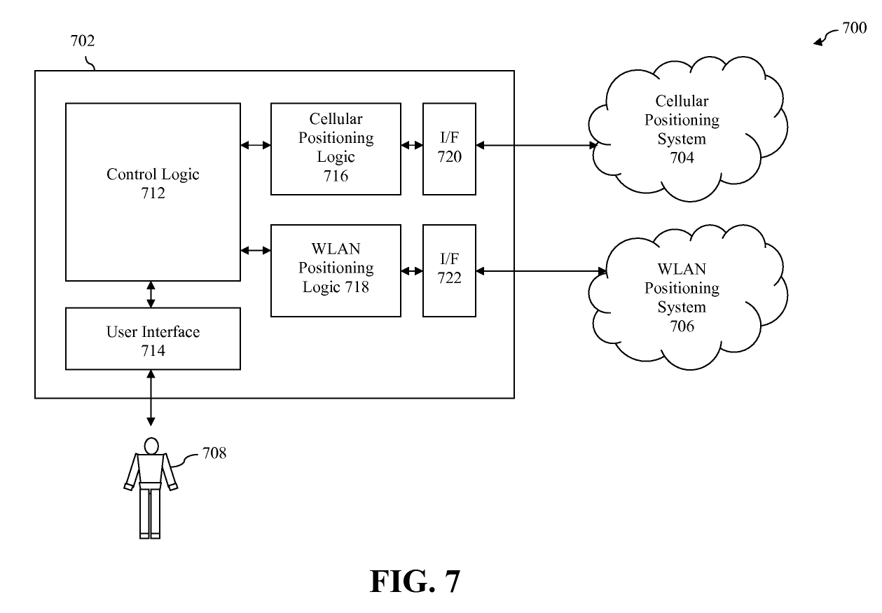

Thus, for example, first positioning system 104 may be a cellular positioning system and second positioning system 106 may be a WLAN positioning system. Such an embodiment is shown in FIG. 7. In particular, as shown in FIG. 7, a system 700 includes a user device 702 that is configured to communicate with a cellular positioning system 704 and a WLAN positioning system 706. Because cellular positioning systems are more susceptible to multipath effects than WLAN positioning systems, this embodiment can be configured to deem WLAN positioning system 706 more reliable than cellular positioning system 704 whenever the user is located within an area of high multipath distortion, in a like manner to the embodiment described in reference to FIGS. 2-5 above. Alternatively, other indicia of reliability may be used to determine which positioning system is more reliable.

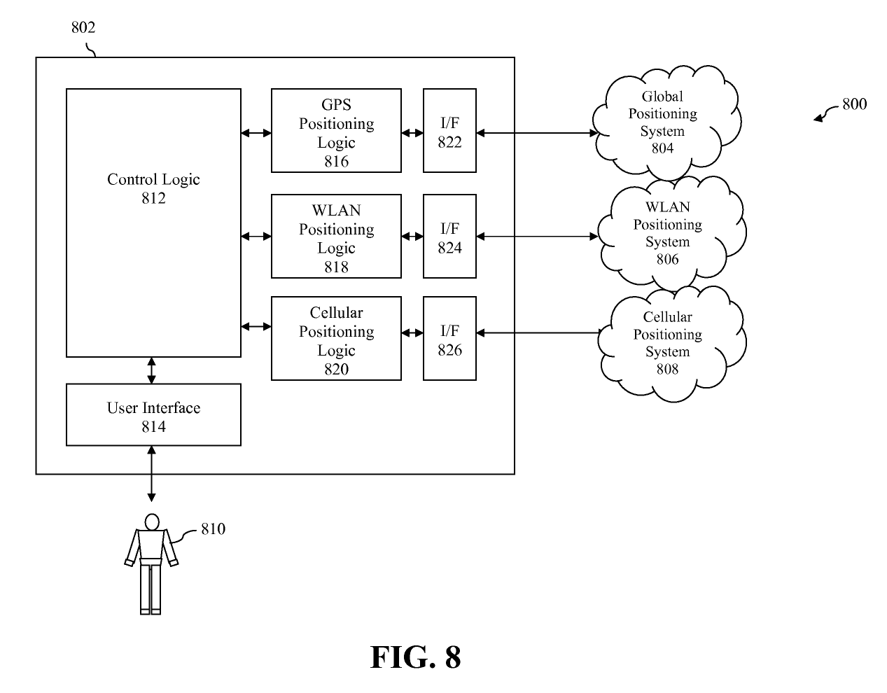

Furthermore, the present invention is not limited to implementations that utilize only two different types of positioning systems. For example, FIG. 8 depicts a system 800 in accordance with an embodiment of the present invention in which a user device 802 is configured to communicate with a GPS 804, a WLAN positioning system 806, and a cellular positioning system 808. User device 802 is also configured to combine location information calculated using two or more of positioning systems 904, 906 and 908 to generate a final location for a user 910. User device 802 may be configured to obtain indicia of reliability with respect to any or all of positioning systems 804, 806 and 808 and then to use such indicia to weigh location information provided by those systems when performing the combination.

### B. Selective Positioning System Usage

In accordance with another aspect of the present invention, a user device that is capable of communicating with multiple positioning systems selects one of the multiple positioning systems to calculate an estimated user location. The one of the multiple positioning systems that is selected is that system that is currently deemed more reliable based on some indicia of reliability. This approach also permits an embodiment of the present invention to provide an accurate estimate of a user's location in rural areas or other sparsely-populated areas as well as in urban areas or other areas prone to high multipath effects.

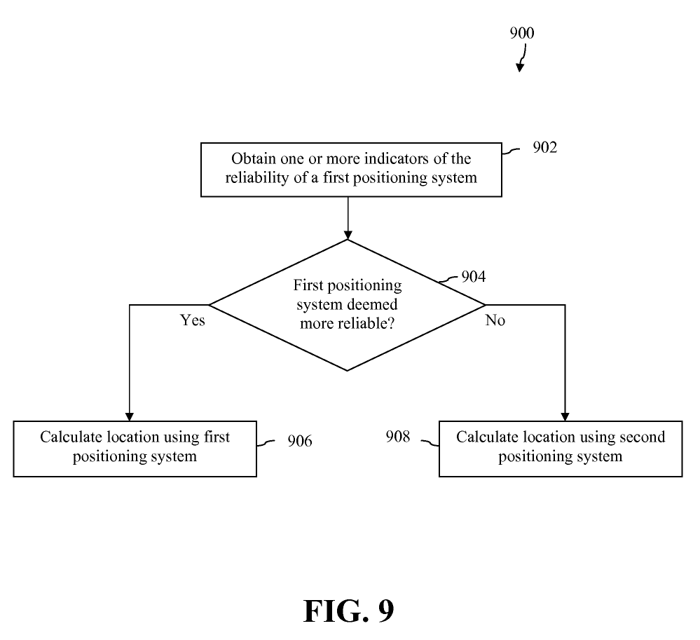

This particular approach will now be described with reference to FIG. 9. In particular, FIG. 9 depicts a flowchart 900 of a method for determining a user location by selectively using one of multiple positioning systems based on indicia of reliability. The method of flowchart 900 will be described with continued reference to system 100 of FIG. 1, although the method is not limited to that embodiment. Persons skilled in the relevant art(s) will appreciate that other devices and systems may be used to implement the method of flowchart 900.

As shown in FIG. 9, the method of flowchart 900 begins at step 902 in which control logic 112 of user device 102 obtains one or more indicators of the reliability of first positioning system 104. The indicator(s) of reliability may be received from first positioning system 104 via interface 120. As discussed above, an indicator of reliability may be any value, signal, or item of information that relates to the current ability of first positioning system 104 to provide accurate location information. As also discussed above, what constitutes an indicator of reliability may vary depending on the type of positioning system.

At decision step 904, control logic 112 determines whether first positioning system 104 is more reliable than second positioning system 106. This determination is based on at least one indicator of reliability obtained in step 902. If first positioning system 104 is deemed more reliable than the second positioning system, then only first positioning system 104 is used to calculate the location of the user, as shown at step 906. However, if first positioning system 104 is not deemed more reliable than second positioning system 106, then only second positioning system 106 is used to calculate the location of the user, as shown at step 908.

One difference between this method and the weighted aiding approaches described above is that it requires only one location to be calculated, thus conserving resources and reducing the complexity of user device 102.

Although the method of flowchart 900 describes obtaining one or more indicators of the reliability of first positioning system 104, persons skilled in the relevant art(s) will appreciate that control logic 112 may also be configured to obtain one or more indicators of the reliability of second positioning system 106 as well. Decision step 904 may then apply an algorithm that determines which positioning system is more reliable based on the indicator(s) received for each positioning system. The positioning system that is deemed more reliable is then used to calculate the location of the user.

Furthermore, although the method of flowchart 900 is described in reference to an embodiment that utilizes only two different types of positioning systems, the present invention is not so limited. Thus, in one embodiment of the present invention, the reliability of three or more different positioning systems is compared and the positioning system deemed the most reliable is used to calculate the user location.

### C. Conclusion

While various embodiments of the present invention have been described above, it should be understood that they have been presented by way of example only, and not limitation. For example, although embodiments of the present invention have been described herein that are configured to interact with GPS, WLAN and cellular positioning systems, the invention is not so limited. Thus embodiments of the present invention may interact with other types of positioning systems either currently existent or subsequently developed.

It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for determining a location, comprising:
obtaining an initial location;
determining if the initial location is within a predefined area; and
combining a first location calculated using a first positioning system with a second location calculated using a second positioning system to calculate a final location,
wherein combining the first location and the second location comprises weighting the second location more heavily than the first location in the combination if the initial location is within the predefined area and weighting the first location more heavily than the second location in the combination if the initial location is not within the predetermined area.

2. The method of claim 1, wherein the predefined area comprises an area prone to multipath distortion.

3. The method of claim 1, wherein combining the first location and the second location comprises:
combining a first location calculated using a Global Positioning System (GPS) with a second location calculated using a non-GPS positioning system.

4. The method of claim 3, wherein combining the first location with the second location comprises:
combining a first location calculated using the GPS with a second location calculated using a wireless local area network (WLAN) positioning system.

5. The method of claim 3, wherein combining the first location with the second location comprises:
combining a first location calculated using the GPS with a second location calculated using a cellular positioning system.

6. The method of claim 1, wherein determining if the initial location is within a predefined area comprises:
comparing the initial location to location information stored in a database.

7. The method of claim 1, wherein obtaining an initial location comprises obtaining a gross location and wherein combining the first location and the second location to calculate a final location comprises combining the first location and the second location to calculate a precise location.

8. The method of claim 1, wherein obtaining the initial location comprises obtaining the initial location using one of the first or the second positioning system.

9. A system, comprising:
first positioning logic configured to calculate a first location using a first positioning system;
second positioning logic configured to calculate a second location using a second positioning system; and
control logic connected to the first positioning logic and the second positioning logic, the control logic configured to obtain an initial location, to determine if the initial location is within a predefined area, and to combine the first location and the second location to calculate a final location,
wherein combining the first location and the second location comprises weighting the second location more heavily than the first location in the combination if the initial location is within the predefined area and weighting the first location more heavily than the second location in the combination if the initial location is not within the predetermined area.

10. The system of claim 9, wherein the predefined area comprises an area prone to multipath distortion.

11. The system of claim 9, wherein the first positioning logic is configured to calculate the first location using a Global Positioning System (GPS).

12. The system of claim 11, wherein the second positioning logic is configured to calculate the second location using a wireless local area network (WLAN) positioning system.

13. The system of claim 11, wherein the second positioning logic is configured to calculate the second location using a cellular positioning system.

14. The system of claim 9, wherein the control logic is configured to determine if the initial location is within a predefined area by comparing the initial location to location information stored in a database.

15. The system of claim 9, wherein the control logic is configured to obtain an initial location by obtaining a gross location and wherein the control logic is configured to combine the first location and the second location to calculate a precise location.

16. The system of claim 9, wherein the control logic is configured to obtain the initial location from one of the first positioning logic or the second positioning logic.

17. A method for determining a location, comprising:
obtaining an indication of the reliability of a first positioning system; and
calculating a location, wherein calculating a location comprises combining a first location calculated using the first positioning system with a second location calculated using a second positioning system, wherein combining the first location and the second location comprises either weighting the second location more heavily than the first location in the combination or weighting the first location more heavily than the second in the combination based on at least the indication of the reliability of the first positioning system.

18. The method of claim 17, wherein combining the first location with the second location comprises combining a first location calculated using a cellular positioning system with a second location calculated using a wireless local area network (WLAN) positioning system.

19. The method of claim 17, wherein calculating a location comprises combining the first location calculated using the first positioning system with the second location calculated using the second positioning system and a third location calculated using a third positioning system.

20. The method of claim 19, wherein combining the first location with the second location and the third location comprises:
combining a first location calculated using a Global Positioning System (GPS) with a second location calculated using a wireless local area network (WLAN) positioning system and a third location calculated using a cellular positioning system.

21. A system, comprising:
first positioning logic configured to calculate a first location using a first positioning system;
second positioning logic configured to calculate a second location using a second positioning system; and
control logic connected to the first positioning logic and the second positioning logic, the control logic configured to obtain an indication of the reliability of the first positioning system and to calculate a location by combining the first location with the second location, wherein combining the first location and the second location comprises either weighting the second location more heavily than the first location in the combination or weighting the first location more heavily than the second in the combination based on at least the indication of the reliability of the first positioning system.

22. The system of claim 21, wherein the first positioning logic is configured to calculate the first position using a cellular positioning system and wherein the second positioning logic is configured to calculate the second position using a wireless local area network (WLAN) positioning system.

23. The system of claim 21, further comprising:
third positioning logic configured to calculate a third location using a third positioning system;
wherein the control logic is configured to calculate the position by combining the first location with the second location and the third location.

24. The system of claim 23, wherein:
the first positioning logic is configured to calculate the first location using a Global Positioning System (GPS);
the second positioning logic is configured to calculate the second location using a wireless local area network (WLAN) positioning system; and
the third positioning logic is configured to calculate the third location using a cellular positioning system.

25. A method for determining a location, comprising:
obtaining an indication of the reliability of a first positioning system; and
calculating a location, wherein calculating a location comprises selectively using either a first positioning system or a second positioning system, wherein the selection is based on at least the indication of the reliability of the first positioning system.
